(19) United States
(12) Patent Application Publication
(10) Pub. No.: US 2015/0278386 A1
(43) Pub. Date: Oct. 1, 2015

(54) UNIVERSAL XML VALIDATOR (UXV) TOOL

(71) Applicant: SYNTEL, INC., Troy, MI (US)

(72) Inventors: Peeyush Kumar Jain, Rajasthan (IN); Tushar Tale, Maharashtra (IN); Narendra S. Naidu, Pune (IN)

(73) Assignee: SYNTEL, INC., Troy, MI (US)

(21) Appl. No.: 14/224,516

(22) Filed: Mar. 25, 2014

(51) Int. Cl. G06F 17/30; G06F 17/22

(52) U.S. Cl. CPC G06F 17/30896; G06F 17/2247; G06F 17/30011

(57) ABSTRACT

A system, method, computer program product for validating an XML document is disclosed. The system may include a scanner module on a computer, a rules module on a computer, and an analyzer module on a computer. The scanner module may be configured to parse the XML document. The rules module may be configured to provide at least one rule, at least one XML schema document or one custom rule. The analyzer module may be configured to analyze the XML document by applying the corresponding XML schema document or the at least one rule to the XML document; and generate a report displaying the results of the analysis.

### TECHNICAL FIELD

The present disclosure relates to validation tools, and, in particular, this disclosure relates to a validation tool for validating extensible markup language (“XML”) documents.

### BACKGROUND AND SUMMARY

XML is a human-readable computer language capable of being interpreted by a wide variety of computer platforms. This feature makes XML an excellent standard for data that is communicated between diverse programs, operating systems and computers. Due to its wide use, it is important that XML documents are validated to ensure that the documents are free of errors and will perform according to their intended use. However, the process of validating XML documents can take a considerable amount of time, particularly when many documents are validated or when a document is very long. Further, there are many types of validations that can be performed on XML documents. Consequently, many users spend a great deal of time attempting to develop several different systems to properly address the various types of validations to ensure their XML documents are properly validated. As such, there is a need for a single universal validation tool capable of performing various types of XML validations.

According to one aspect, the disclosure provides systems, methods, and computer program products for validating an XML document. Embodiments may include a scanner module, a rules module, and an analyzer module on a computer. The scanner module parses the XML document. The rules module may be configured to provide at least one rule or at least one XML schema document. The analyzer module may be configured to analyze the XML document by applying the corresponding XML schema document or apply at least one rule to the XML document; and generate a report displaying the results of the analysis.

Additional features and advantages of the invention will become apparent to those skilled in the art upon consideration of the following detailed description of the illustrated embodiment exemplifying the best mode of carrying out the invention as presently perceived.

### BRIEF DESCRIPTION OF DRAWINGS

The present disclosure will be described hereafter with reference to the attached drawings which are given as non-limiting examples only, in which:

FIG. 1 is a high level diagrammatical view of the tool according to one embodiment of the disclosure;

FIG. 2 is an example screenshot displaying results of a validation according to one embodiment of the disclosure;

FIG. 3 is an example screenshot illustrating the validation tool's ability to export results of the validation to a spreadsheet according to one embodiment of the disclosure; and

FIG. 4 is a diagrammatical view of an example computing device that may be included in the tool and that may be programmed to carry out various methods taught herein according to one embodiment of the disclosure.

Corresponding reference characters indicate corresponding parts throughout the several views. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

Embodiments of the disclosure are directed to a computerized system programmed with an Universal XML Validator (UXV) tool that is configured to validate XML documents using a variety of validation techniques. By way of example only, the Universal XML Validator (UXV) tool could be configured to perform validations using XML Schema, XML Path Language (“XPath”) of the Extensible stylesheet language family (“XSL”), Schematron, and/or possible customized validations.

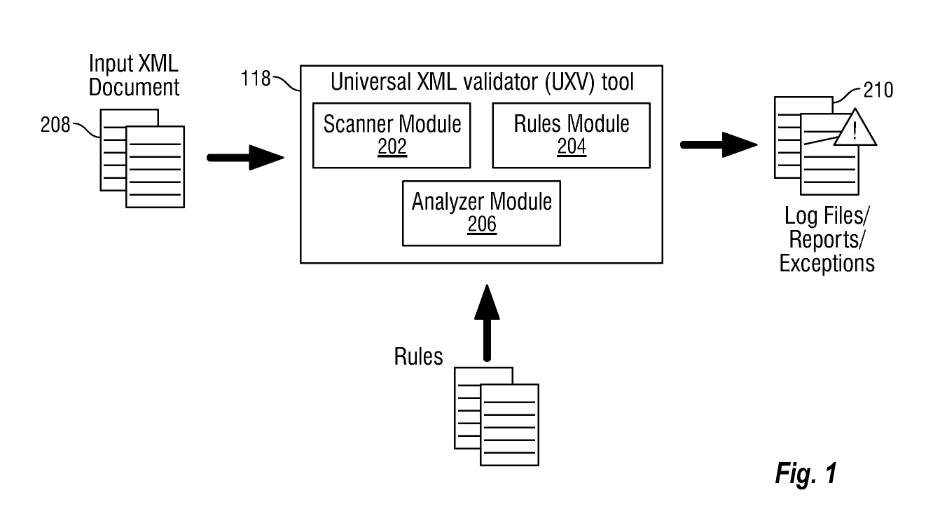

FIG. 1 is an example system architecture that may be used for the validation tool 118. In the example shown, the validation tool 118 includes a scanner module 202, a rules module 204, and an analyzer module 206. For the purposes of this specification, the term “module” includes an identifiable portion of computer code, computational or executable instructions, data, or computational object to achieve a particular function, operation, processing, or procedure. A module may be implemented in software, hardware/circuitry, or a combination of software and hardware. An identified module of executable code, for example, may comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, modules representing data may be embodied in any suitable form and organized within any suitable type of data structure. The data may be collected as a single data set, or may be distributed over different locations including over different storage devices.

An input XML document 208 typically includes a plurality of elements. An XML element represents a structure within the XML document 208 and generally includes a start tag, content, and an end tag. An element can contain other elements. In addition, elements can have attributes providing information about the elements. An attribute's value may be enclosed either in single quotes or double quotes. The following is an example:

<person gender = “male”>
<firstname>Mark</firstname>
<lastname>Johnson</lastname>
</person>

In the above example, <person> is a start tag with </person> being the corresponding end tag, <firstname> is a start tag and </firstname> is the end tag, and <lastname> is a start tag with an end tag </lastname>. So there are three elements: “person”, “firstname”, “lastname”. Further, “first name” and “last name” are sub-elements of the element “person”. “Mark” and “Johnson” are contents. The element “person” also has an attribute (gender=“male”).

XML documents may be hierarchical. For example, XML documents may contain a sequence of parent and child elements where one or more elements may be child elements of a parent element. According to embodiments of the disclosure, the scanner module 202 parses the input XML document 208 into components (e.g., by each of its elements, attributes, content, etc.). These parsed components are translated to a form suitable for analysis. This translation may be into either a stream of events via a simple application programming interface (“SAX”) parser, or a data object model (“DOM”) parser.

As used herein, the SAX parser is a standard programming interface designed for parsing XML documents through an event-based architecture. That is to say, SAX is a type of event callback interface whereby an application developer implements a set of “callback” methods or routines, each of which corresponds to an event that can occur during parsing of the XML document. For example, the SAX parser recognizes strings in the form <tag> as element start tags and strings in the form </tag> as element end tags. Each such start or end tag generates an “event” that initiates appropriate parsing by the parser to identify and extract the elements and data values associated with the start and/or end tag.

Depending on the circumstances, the scanner module may employ the use of the afore-mentioned DOM parser. The DOM parser may extract data from the XML documents and builds an internal tree representation of the XML document for analysis by the analyzer module 206.

It is important to note, that, regardless of the type of parser used (e.g., DOM, SAX, etc.), the parser oftentimes has difficulty properly translating, if at all, an XML document that does not adhere to a particular format, or, in other words, not “well-formed.” As used herein, a “well-formed” XML document is an XML document that adheres to particular, syntactical, grammar, and/or structural rules as defined by the World Wide Web Consortium (“WC3”), the main international standards organization for the World Wide Web. Following these guidelines, an XML document must have a single root element, the elements must be properly nested, tag names cannot begin with a number or contain certain characters, and so on. As such, the scanner module 202 may also check the XML document for adherence to these rules prior to being parsed. In the case that the XML document fails to meet these standards, because errors may cause the XML document not to parse, the scanner module 202 may report any violations by flagging the particular line(s) as an error, and alert the user to make an appropriate correction as shown by the log file/reports/exception 210.

According to embodiments of the disclosure, the rules module 204 may provide a set of rules or any locally referenced XML schema for a user to select from for document validation. These validation rules can allow a user with little or no programming ability to create a broad range of useful validation rules. Further, the user can create additional rules, and remove existing rules for a more customized validation operation. The tool may include predefined rules including but not limited to the following:
Max length should be defined for all public fields.
Comments section should be fully utilized for important fields.
Public Element should not be used for internal calculation.
Private fields should be used in calculation, iteration and lookup.
Option List Values should be stored using the full value of the limit.
Option List Captions should be properly formatted.
The rating factor fields should contain a ignore look up.

Also included in the validation tool 118 is the analyzer module 206. The analyzer module 206 performs an analysis of each scanned XML document according to the desired validation technique (e.g., XML Schema, Schematron/XPath, customized validations etc.) and input rules. The XML Analyzer then generates one or more reports detailing the results of the validation.

As discussed herein, an XML document may have an accompanying XML schema. An XML schema is a description of an XML document including predefined elements and attributes describing the structure of its corresponding XML document. In other words, the XML Schema may be used to express a set of rules to which an XML document must conform in order to be considered ‘valid’ according to that schema. For example, the XML Schema can include information including, but not limited to element declarations (which define properties of elements), attribute declarations (which define properties of declarations), complex type declarations (element declarations of elements that contain other elements), and the like.

In light of the foregoing, the analyzer module 206 receives the input XML document 208 (such as from the scanner) and the corresponding XML Schema (such as, from the rules module 204, or retrieved elsewhere as specified in the XML document). The analyzer then iterates through the XML document, comparing each component (e.g., element, attribute, and the like) with any constraints on the objects as specified in the XML Schema.

The validation tool may also perform validation using XPath functionality, an aspect of the Extensible Style Language (“XSL”) for selecting portions of an XML document. XSL is defined by the W3C, and is one style language used by XML and allows different clients to receive the same XML documents in different formats. The XPath functionality provides the user with the ability to navigate through an XML document, (e.g., by specific element or attribute names and values). XPath defines pattern matching to find a specific element or attribute by a variety of criteria through the use of XPATH expressions. For example, //b (finds all occurrences of <b> in the XML document. It should be noted that the user can select from existing rules (such as those stored in the rules module 204), or create additional rules. In operation, the user may enter an XPATH expression to locate certain portions of the XML document to be validated. The user may then select, or create, rules to be applied to the located XML document portions.

The validation tool may also perform validation using Schematron. As used herein, “Schematron” is a declarative assertion language using XML syntax developed by Rick Jelliffe, a member of the W3C XML Schema Working Group, and is a set of rules using aforediscussed XPath expressions, another W3C Recommendation, that can be used to specify relationships between different elements.

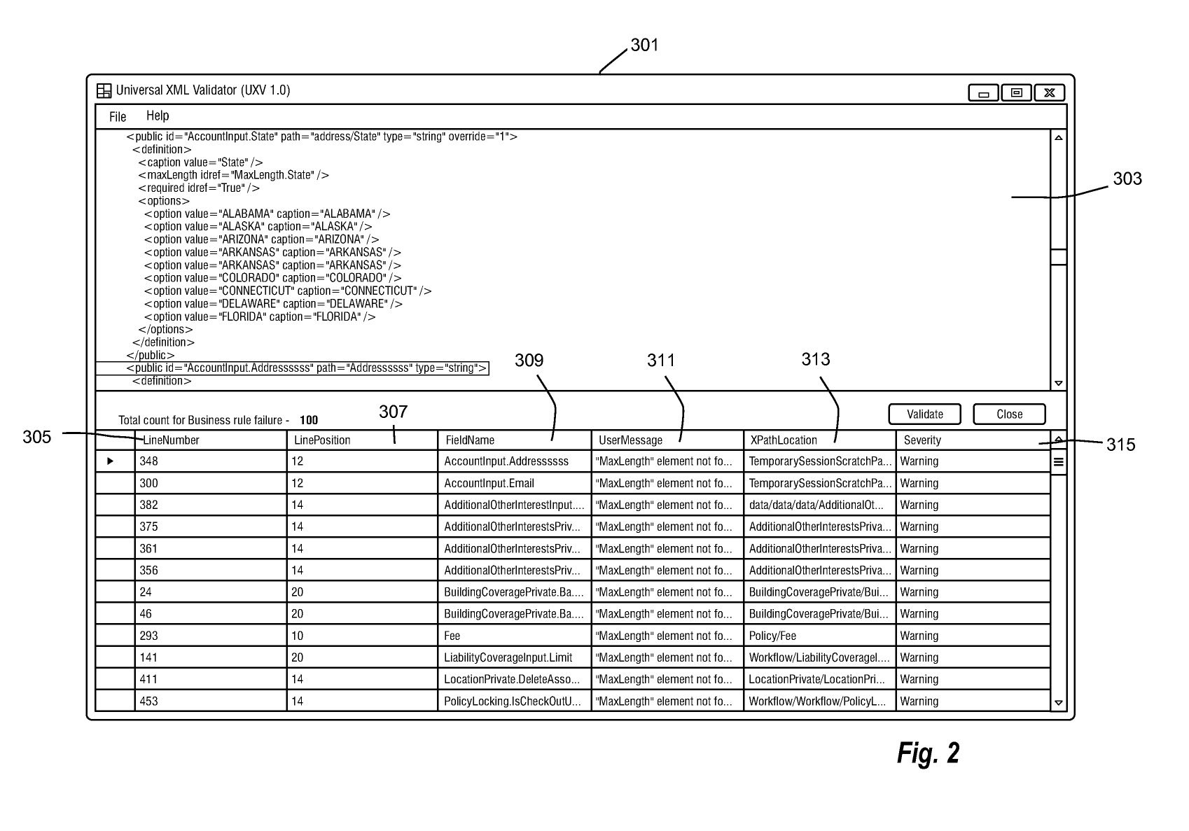

FIG. 2 illustrates an example screenshot 301 showing operation of the validation tool using the XPath functionality. The XML document to be validated is shown in the dominant window 303. As discussed above, XPath allows a user to locate and subsequently validate specific portions of the XML document. For example, the user may be able to enter, or select an XPath Expression for the validation tool to match, or assert a presence of a pattern, to validate portions of the XML document of interest. Thus, and as shown in FIG. 2, the portions of interest may be identified by line number 305, line position 307, field name 309, error message 311, XPath location 313, and severity 315 of the business rule failure. With respect to the example XML document as shown in FIG. 2, the validation tool flagged an error in line 348 of the XML document stating that the “MaxLength” element was not found. With respect to the same violation of this business rule, the validation tool shows this error has a line position of “12”, and a field name of “AccountInput. Addressessssss”.

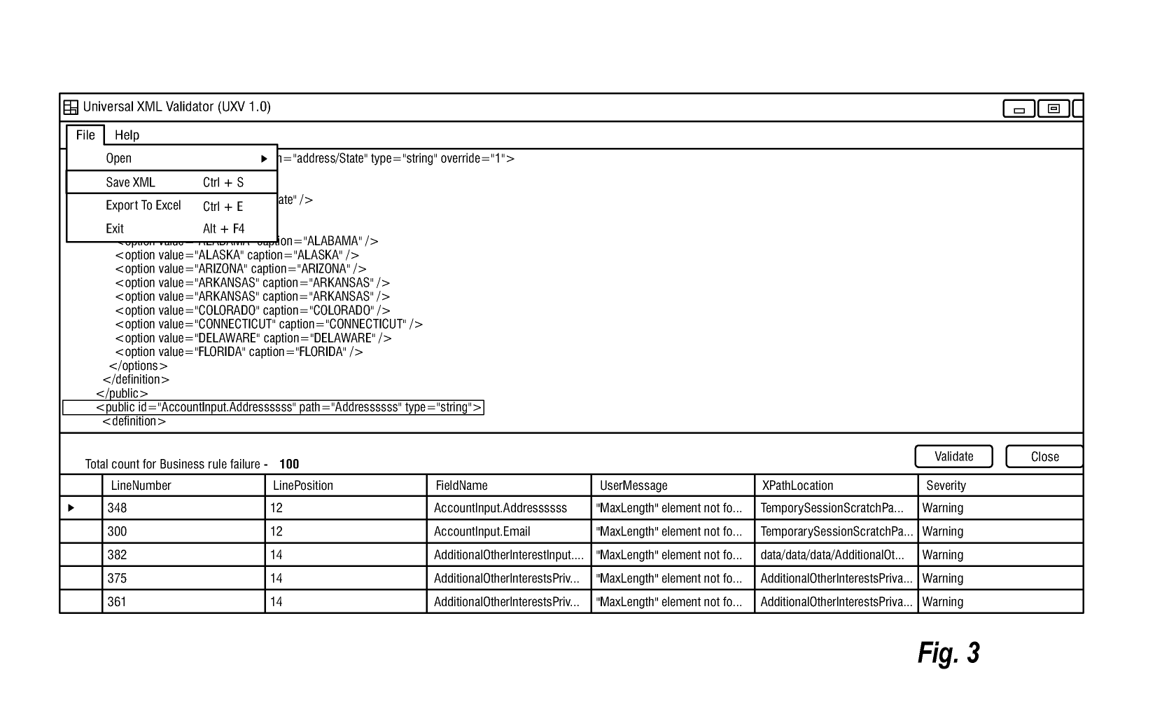

As shown in FIG. 3, the validation tool 118 also allows the user to export the validated, or failed XML document including details of all warnings, explanations, and any other of the afore-discussed results, to a spreadsheet, such as Microsoft Excel™, offered by Microsoft Corporation of Redmond, Wash.

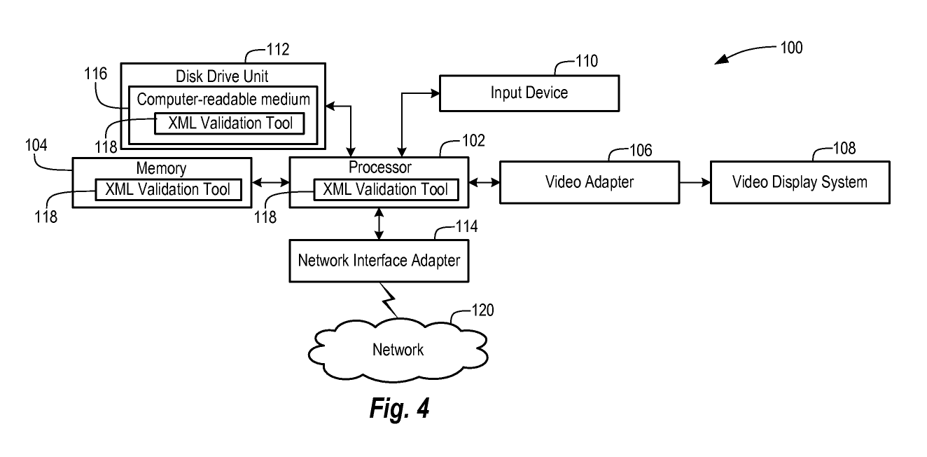

FIG. 4 illustrates a diagrammatic representation of a machine 100 in the example form of a computer system, that may be programmed with a set of instructions to perform any one or more of the methods discussed herein. The machine may be a personal computer, a notebook computer, a server, a tablet computer, a personal digital assistant (“PDA”), a cellular telephone, or any machine capable of executing a set of instructions (sequential or otherwise) that specify actions to be taken by that machine.

The machine 100 may operate as a standalone device or may be connected (e.g., networked) to other machines. In embodiments where the machine is a standalone device, the set of instructions could be a computer program stored locally on the device that, when executed, causes the device to perform one or more of the methods discussed herein. In embodiments where the computer program is locally stored, data may be retrieved from local storage or from a remote location via a network. In a networked deployment, the machine 100 may operate in the capacity of a server or a client machine in server-client network environment, or as a peer machine in a peer-to-peer (or distributed) network environment. Although only a single machine is illustrated in FIG. 1, the term “machine” shall also be taken to include any collection of machines that individually or jointly execute a set (or multiple sets) of instructions to perform any one or more of the methods discussed herein.

The example machine 100 illustrated in FIG. 4 includes a processor 102 (e.g., a central processing unit (“CPU”)), a memory 104, a video adapter 106 that drives a video display system 108 (e.g., a liquid crystal display (“LCD”) or a cathode ray tube (“CRT”)), an input device 110 (e.g., a keyboard, mouse, touch screen display, etc.) for the user to interact with the program, a disk drive unit 112, and a network interface adapter 114. Note that various embodiments of the machine 100 will not always include all of these peripheral devices.

The disk drive unit 112 includes a computer-readable medium 116 on which is stored one or more sets of computer instructions and data structures embodying or utilized by a validation tool 118 described herein. The computer instructions and data structures may also reside, completely or at least partially, within the memory 104 and/or within the processor 102 during execution thereof by the machine 100; accordingly, the memory 104 and the processor 102 also constitute computer-readable media. Embodiments are contemplated in which the validation tool 118 may be transmitted or received over a network 120 via the network interface device 114 utilizing any one of a number of transfer protocols including but not limited to the hypertext transfer protocol (“HTTP”) and file transfer protocol (“FTP”).

The network 120 may be any type of communication scheme including but not limited to fiber optic, cellular, wired, and/or wireless communication capability in any of a plurality of protocols, such as TCP/IP, Ethernet, WAP, IEEE 802.11, or any other protocol.

While the computer-readable medium 116 shown in the example embodiment of FIG. 4 is a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing a set of instructions for execution by the machine and that cause the machine to perform any one or more of the methods described herein, or that is capable of storing data structures utilized by or associated with such a set of instructions. The term “computer-readable medium” shall accordingly be taken to include, but not be limited to, solid-state memories, optical media, flash memory, and magnetic media.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A computerized system for validating an extensible markup language (“XML”) document, the system comprising:
a scanner module on a computer configured to parse the XML document;
a rules module on a computer configured to provide at least one pre-defined rule, or at least one customized rule, or at least one XML schema document;
an analyzer module on a computer configured to:
analyze the XML document by:
applying the XML schema corresponding to the XML document; or
applying the at least one pre-defined rule or the at least one customized rule to the portion using an XML Path Language (“XPath”); and
generate a report displaying the results of the analysis.

2. The computerized system of claim 1, wherein the analyzer module is further configured to enumerate through each object within the parsed XML document.

3. The computerized system of claim 1, wherein the scanner module is further configured to determine whether the XML document complies with pre-defined syntactical and grammatical rules.

4. The computerized system of claim 1, wherein the scanner module is further configured to parse the portion of the XML document in accordance with a document object model.

5. The computerized system of claim 1, wherein the at least one rule is applied using a declarative assertion language.

6. The computerized system of claim 1, wherein the analyzer module is further configured to identify a location of a portion of the XML document failing to comply with the at least one rule.

7. The computerized system of claim 1, wherein the analyzer module is further configured to:
allow selection of one or more portions of the XML document; and
apply the at least one pre-defined rule only to the selected one or more portions of the XML document.

8. A computerized system for validating an extensible markup language (“XML”) document, the system comprising:
one or more computing devices including:
a memory having program code stored therein;
a processor in communication with the memory configured to carry out instructions in accordance with the stored program code, wherein the program code, when executed by the processor, causes the processor to perform operations comprising:
parsing a portion of the XML document;
comparing the portion to a corresponding XML schema document;
applying at least one pre-defined rule and at least one customized rule to the portion using an XML Path language expression; and
generating a report displaying the results of the comparison and the application of the at least one pre-defined rule.

9. The computerized system of claim 8, further comprising parsing the XML document in accordance with a document object model.

10. The computerized system of claim 8, further comprising determining whether the portion of the XML document complies with pre-defined syntactical and grammatical rules.

11. The computerized system of claim 8, further comprising identifying a location of a portion of the XML document failing to comply with the at least one rule.

12. The computerized system of claim 8, further comprising allowing selection of one or more portions of the XML document; and applying the at least one pre-defined rule only to the selected one or more portions of the XML document.

13. The computerized system of claim 8, further comprising allowing selection of one or more portions of the XML document; and applying the at least one pre-defined rule and the at least one customized rule only to the selected one or more portions of the XML document.

14. A computerized method for validating an extensible markup language (“XML”) document, the method comprising:
parsing, by a processor, the XML document;
providing, by a processor, at least one pre-defined rule, at least one customized rule, or at least one XML schema document;
analyzing, by a processor, the portion of the XML document by:
applying the XML schema corresponding to the portion of the XML document; and
applying, by a processor, the at least one pre-defined rule to the portion using an XML Path Language (“XPath”); and
generating, by a processor, a report displaying the results of the analysis and the application of the at least one pre-defined rule.

15. The computerized method of claim 14, further comprising:
enumerating through each object within the parsed XML document.

16. The computerized method of claim 14, further comprising:
determining whether the XML document complies with pre-defined syntactical and grammatical rules.

17. The computerized method of claim 14, further comprising:
identifying a location of a portion of the XML document failing to comply with the at least one rule.

18. The computerized method of claim 14, further comprising:
parsing the XML document in accordance with a document object model.

19. The computerized method of claim 14, further comprising:
allowing selection of one or more portions of the XML document; and
applying the at least one pre-defined rule only to the selected one or more portions of the XML document.

20. The computerized method of claim 14, further comprising:
allowing selection of one or more portions of the XML document; and
applying the at least one pre-defined rule and the at least one customized rule only to the selected one or more portions of the XML document.
